(19) United States
(12) Patent Application Publication
(10) Pub. No.: US 2012/0306296 A1
(43) Pub. Date: Dec. 6, 2012

(54) SWITCHED RELUCTANCE MOTOR

(75) Inventors: Changsung Sean Kim, Gyunggi-do (KR); Chang Hwan Choi, Gyunggi-do (KR); Han Kyung Bae, Gyunggi-do (KR)

(73) Assignee: SAMSUNG ELECTRO-MECHANICS CO., LTD., Gyunggi-do (KR)

(21) Appl. No.: 13/232,522

(22) Filed: Sep. 14, 2011

(30) Foreign Application Priority Data
Jun. 2, 2011 (KR) 1020110053478
Jun. 22, 2011 (KR) 1020110060873

(51) Int. Cl. H02K 37/06

(52) U.S. Cl. 310/46

(57) ABSTRACT

Disclosed herein is a switched reluctance motor in which an outer rotor provided with a plurality of salient poles protruded at equidistance along an inner peripheral surface thereof; and a stator provided in the outer rotor, provided with a plurality of stator cores including main salient poles protruded toward the salient poles of the outer rotor and including coils wound therearound and auxiliary salient poles positioned at both sides of the main salient poles, and having phase windings in which the coils are wound around the main salient poles are provided, a magnetic flux is bisected in the main salient pole and flows into the auxiliary salient poles of adjacent phase windings, such that a short magnetic flux route is implemented, thereby making it possible to reduce core loss, and a magnet is also provided, thereby making it possible to improve torque characteristics.

### CROSS REFERENCE TO RELATED APPLICATION

This application claims the benefit of Korean Patent Application Nos. 10-2011-0053478 filed on Jun. 2, 2011 and 10-2011-0060873 filed on Jun. 22, 2011, entitled “Switched Reluctance Motor”, which is hereby incorporated by reference in their entireties into this application.

### BACKGROUND OF THE INVENTION

1. Technical Field

The present invention relates to a switched reluctance motor.

2. Description of the Related Art

Recently, a demand for a motor has been largely increased in various industries such as vehicles, aerospace, military, medical equipment, or the like. In particular, a cost of a motor using a permanent magnet is increased due to the sudden price increase of a rare earth material, such that a switched reluctance (SR) motor has become interested as a new alternative.

A driving principle of an SR motor rotates a rotor using a reluctance torque generated according to the change in magnetic reluctance.

As shown in FIG. 1, a switched reluctance motor 100 according to the prior art includes a rotor 110 and a stator 120, wherein the rotor 110 is provided with a plurality of rotor salient poles 111 and the stator 120 is provided with a plurality of stator salient poles 121 opposite to the rotor salient poles 111. Further, a coil 130 is wound around the stator salient poles 121.

Further, the rotor 110 is configured of only a core without any type of excitation device, for example, a winding of a coil or a permanent magnet.

Therefore, when current flows in the coil 130 from the outside, the rotor 110 generates reluctance torque moving in the coil 130 direction by magnetic force generated from the coil 130, such that the rotor 110 rotates in a direction in which resistance of a magnetic circuit is minimized.

However, the switched reluctance motor 100 according to the prior art may lead to core loss since a magnetic flux passes through both of the stator 120 and the rotor 110.

### SUMMARY OF THE INVENTION

The present invention has been made in an effort to provide a switched reluctance motor in which a stator core provided with main salient poles around which coils are wound and auxiliary salient poles around which coils are not wound is provided, a magnetic flux is bisected in the main salient pole and flows into the auxiliary salient poles of adjacent phase windings, such that a short magnetic flux route is implemented, thereby making it possible to reduce core loss, and a magnet is provided, thereby making it possible to improve torque characteristics.

According to a first preferred embodiment of the present invention, there is provided a switched reluctance motor including: an outer rotor provided with a plurality of salient poles protruded at equidistance along an inner peripheral surface thereof; and a stator provided in the outer rotor, provided with a plurality of stator cores including main salient poles protruded toward the salient poles of the outer rotor and including coils wound therearound and auxiliary salient poles positioned at both sides of the main salient poles, and having phase windings in which the coils are wound around the main salient poles.

A magnetic flux generated due to excitation of the phase winding of the stator may be bisected in the main salient pole and flow into auxiliary salient poles of adjacent phase windings.

The main salient pole may have a cross-sectional area larger than that of the auxiliary salient pole in a direction perpendicular to a shaft.

Ten salient poles of the outer rotor may be formed at equipitch with respect to a circumferential direction, six main salient poles of the stator may be formed at equipitch with respect to the circumferential direction, the coils may be wound around the main salient poles to form three-phase windings, and twelve auxiliary salient poles may be formed at both sides of the main salient poles.

The outer rotor may further include soundproofing materials filled between the salient poles thereof.

The soundproofing material may be a non-magnetic material or an insulating material.

According to a second preferred embodiment of the present invention, there is provided a switched reluctance motor including: an outer rotor provided with a plurality of salient poles protruded at equidistance along an inner peripheral surface thereof; and a stator provided in the outer rotor, provided with a plurality of stator cores including main salient poles protruded toward the salient poles of the outer rotor and including coils wound therearound and auxiliary salient poles positioned at both sides of the main salient poles, having phase windings in which the coils are wound around the main salient poles, and including magnets mounted between the phase windings.

A magnetic flux generated due to excitation of the phase winding of the stator may be bisected in the main salient pole and flow into auxiliary salient poles of adjacent phase windings.

The main salient pole may have a cross-sectional area larger than that of the auxiliary salient pole in a direction perpendicular to a shaft.

Ten salient poles of the outer rotor may be formed at equipitch with respect to a circumferential direction, six main salient poles of the stator may be formed at equipitch with respect to the circumferential direction, the coils may be wound around the main salient poles to form a three-phase winding, and twelve auxiliary salient poles may be formed at both sides of the main salient poles.

### BRIEF DESCRIPTION OF THE DRAWINGS

FIG. 1 is a schematic cross-sectional view of a switched reluctance motor according to the prior art;

FIG. 2 is a schematic cross-sectional view of a switched reluctance motor according to a first preferred embodiment of the present invention;

FIG. 3 is a schematic perspective view of the switched reluctance motor shown in FIG. 2;

FIGS. 4 to 8 are schematic views showing a use state of the switched reluctance motor shown in FIG. 2;

FIG. 9 is a schematic cross-sectional view of a switched reluctance motor including an outer rotor according to another preferred embodiment of the present invention;

FIG. 10 is a schematic cross-sectional view of a switched reluctance motor according to a second preferred embodiment of the present invention;

FIG. 11 is a perspective view of the switched reluctance motor shown in FIG. 10;

FIGS. 12 to 16 are schematic views showing a use state of the switched reluctance motor shown in FIG. 10;

FIG. 17 is a schematic cross-sectional view of a switched reluctance motor according to a third preferred embodiment of the present invention; and

FIG. 18 is a schematic cross-sectional view of a switched reluctance motor according to a fourth preferred embodiment of the present invention.

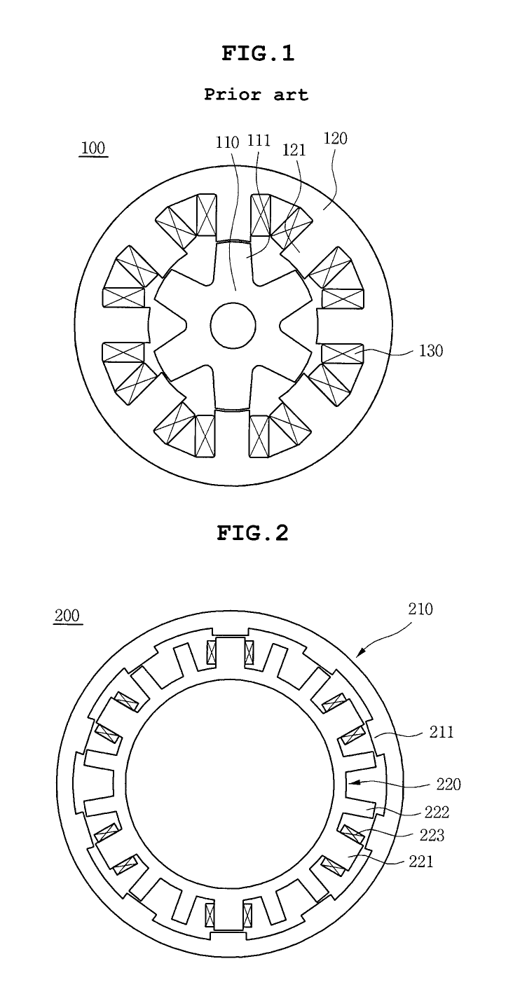

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

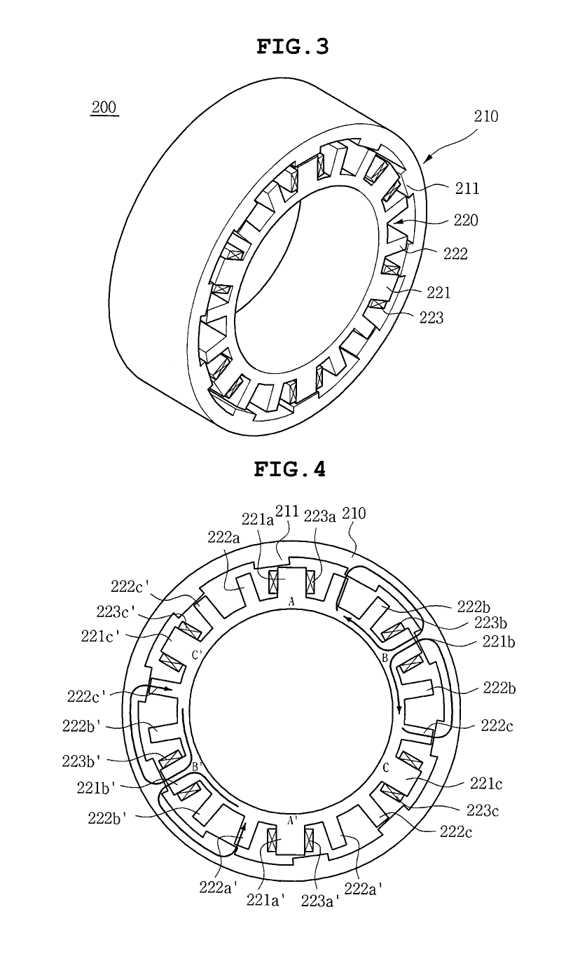

FIG. 2 is a schematic cross-sectional view of a switched reluctance motor according to a first preferred embodiment of the present invention; and FIG. 3 is a schematic perspective view of the switched reluctance motor shown in FIG. 2. As shown, a switched reluctance motor 200 according to a first preferred embodiment of the present invention includes an outer rotor 210 and a stator 220, wherein the outer rotor 210 rotates in one direction by a reluctance torque with the stator 220.

More specifically, the outer rotor 210 is provided with a plurality of salient poles 211 protruded at equidistance along an inner peripheral surface thereof.

In addition, the stator 220 is provided in the outer rotor 210 and is provided with a plurality of stator cores including main salient poles 221 and auxiliary salient poles 222 that are protruded toward the salient poles 211 of the outer rotor. In addition, the main salient poles 221 have coils 223 wound therearound to form phase windings, and the auxiliary salient poles 222 serve as a bridge when a magnetic flux flows and are positioned at both sides of the main salient poles 221, without a coil wound therearound.

Through the above-mentioned configuration, the magnetic flux generated in the main salient pole is bisected and flows into auxiliary salient poles of adjacent phase windings, as shown in FIG. 4. To this end, the main salient pole 221 according to the first preferred embodiment of the present invention may have a cross-sectional area larger, for example, two times larger, than that of the auxiliary salient pole 222 in a direction perpendicular to a shaft.

In addition, in the switched reluctance motor 200 according to the first preferred embodiment of the present invention, ten salient poles 211 of the outer rotor 210 are formed at equipitch with respect to a circumferential direction, six main salient poles 221 of the stator 220 are formed at equipitch with respect to the circumferential direction, the coils 223 are wound around the main salient poles 221 to form three-phase windings, and twelve auxiliary salient poles are formed at both sides of the main salient poles.

Further, the switched reluctance motor 200 according to the preferred embodiment of the present invention may also be implemented as a drainage structure in which twenty salient poles of the outer rotor are formed at equipitch with respect to the circumferential direction, twelve main salient poles of the stator are formed at equipitch with respect to the circumferential direction, the coils are wound around the main salient poles, and twenty four auxiliary salient poles are formed at both sides of the main salient poles.

FIGS. 4 to 8 are schematic views showing a use state of the switched reluctance motor shown in FIG. 2. As shown, the switched reluctance motor 200 according to the first preferred embodiment of the present invention is a three-phase switched reluctance motor. In addition, as shown in FIG. 4, when an A-phase winding 223a, which is a first-phase winding, has a current applied thereto to be excited, thereby generating a magnetic flux, the magnetic flux is bisected in a main salient pole 221a and flows into auxiliary salient poles of phase windings adjacent to the A-phase winding 223a at both sides thereof, that is, an auxiliary salient pole 222b of a B-phase winding, which is a second-phase winding, and an auxiliary salient pole 222c′ of a C′-phase winding, which is a third-phase winding, respectively, through the salient pole 211 of the outer rotor 210.

Likewise, when an A′-phase winding 223a′, which is a first-phase winding, formed at an opposite side to the A-phase winding 223a in a radial direction of the stator 220, has a current applied thereto to be excited, thereby generating a magnetic flux, the magnetic flux is bisected in a main salient pole 221a′ and flows into auxiliary salient poles of phase windings adjacent to the A-phase winding 223a′ at both sides thereof, that is, an auxiliary salient pole 222b′ of a B′-phase winding, which is a second-phase winding, and an auxiliary salient pole 222c of a C-phase winding, which is a third-phase winding, respectively, through the salient pole 211 of the outer rotor 210.

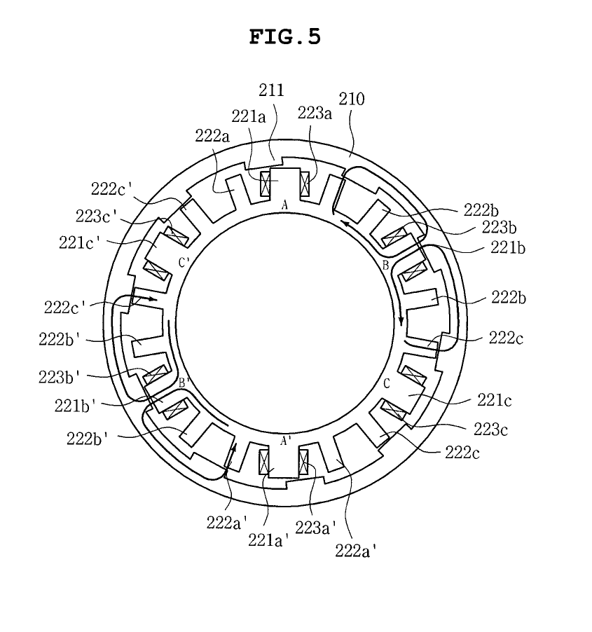

FIG. 5 shows a state in which excitation according to application of a current is changed from the A-phase winding into the B-phase winding, wherein the outer rotor 210 is in a state in which it rotates by 7.2 degrees in a counterclockwise direction as compared to FIG. 4. In this case, a magnetic flux generated by applying a current to a B-phase winding 223b, which is a second-phase winding, is bisected in a main salient pole 221b and flows into auxiliary salient poles of phase windings adjacent to the B-phase winding 223b at both sides thereof, that is, an auxiliary salient pole 222c of a C-phase winding, which is a third-phase winding, and an auxiliary salient pole 222a of an A-phase winding, which is a first-phase winding, respectively, through the salient pole 211 of the outer rotor 210.

Likewise, a magnetic flux generated by applying a current to a B′-phase winding 223b′, which is a second-phase winding, is bisected in a main salient pole 221b′ and flows into auxiliary salient poles of phase windings adjacent to the B′-phase winding 223b′ at both sides thereof, that is, an auxiliary salient pole 222a′ of an A′-phase winding, which is a first-phase winding, and an auxiliary salient pole 222c′ of a C′-phase winding, which is a third-phase winding, respectively, through the salient pole 211 of the outer rotor 210.

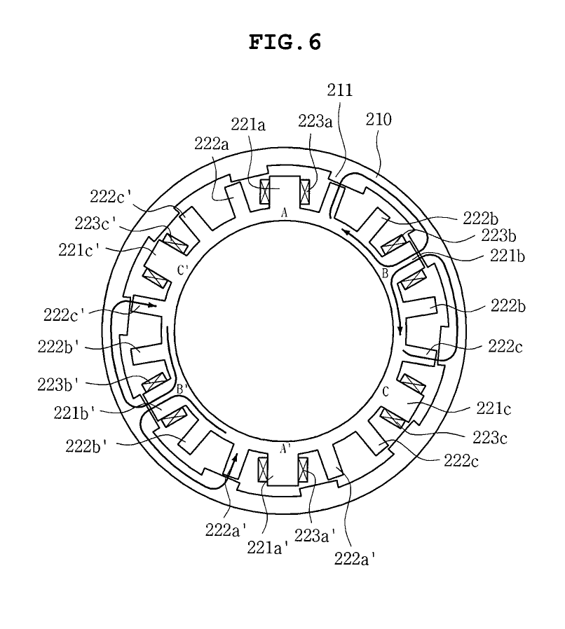

FIG. 6 shows a state in which a B-phase winding is excited by applying a current to the B-phase winding. More specifically, the outer rotor 210 is in a state in which it rotates by 7.2 degrees in a counterclockwise direction as compared to FIG. 5 and by 14.4 degrees in a counterclockwise direction as compared to FIG. 4. In this case, a magnetic flux generated by applying a current to the B-phase winding 223b, which is a second-phase winding, is bisected in the main salient pole 221b and flows into the auxiliary salient poles of the phase windings adjacent to the B-phase winding 223b at both sides thereof, that is, the auxiliary salient pole 222c of the C-phase winding, which is a third-phase winding, and the auxiliary salient pole 222a of the A-phase winding, which is a first-phase winding, respectively, through the salient pole 211 of the outer rotor 210.

Likewise, a magnetic flux generated by applying a current to the B′-phase winding 223b′, which is a second-phase winding, is bisected in the main salient pole 221b′ and flows into the auxiliary salient poles of the phase windings adjacent to the B′-phase winding 223b′ at both sides thereof, that is, the auxiliary salient pole 222a′ of the A′-phase winding, which is a first-phase winding, and the auxiliary salient pole 222c′ of the C′-phase winding, which is a third-phase winding, respectively, through the salient pole 211 of the outer rotor 210.

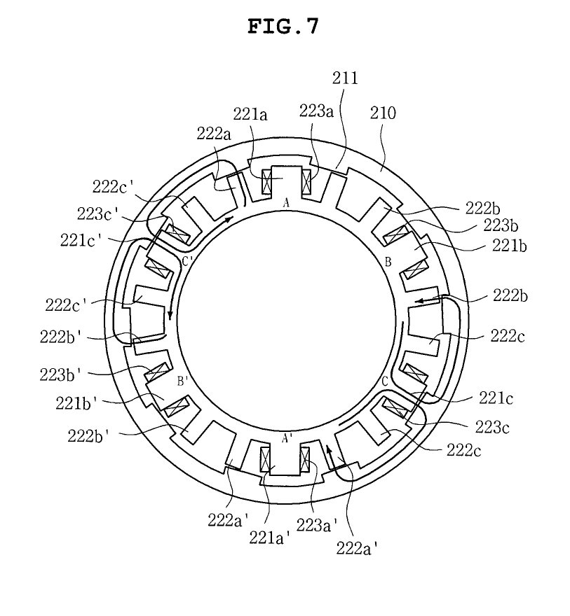

FIG. 7 shows a state in which excitation according to application of a current is changed from the B-phase winding into the C-phase winding, wherein the outer rotor 210 is in a state in which it rotates by 7.2 degrees in a counterclockwise direction as compared to FIG. 6 and by 21.6 degrees in a counterclockwise direction as compared to FIG. 4.

In this case, a magnetic flux generated by applying a current to a C-phase winding 223c, which is a third-phase winding, is bisected in a main salient pole 221c and flows into auxiliary salient poles of phase windings adjacent to the C-phase winding 223c at both sides thereof, that is, an auxiliary salient pole 222b of a B-phase winding, which is a second-phase winding, and an auxiliary salient pole 222a′ of an A′-phase winding, which is a first-phase winding, respectively, through the salient pole 211 of the outer rotor 210.

Likewise, a magnetic flux generated by applying a current to a C′-phase winding 223c′, which is a second-phase winding, is bisected in a main salient pole 221c′ and flows into auxiliary salient poles of phase windings adjacent to the C′-phase winding 223c′ at both sides thereof, that is, an auxiliary salient pole 222a′ of an A-phase winding, which is a first-phase winding, and an auxiliary salient pole 222b′ of a B-phase winding, which is a second-phase winding, respectively, through the salient pole 211 of the outer rotor 210.

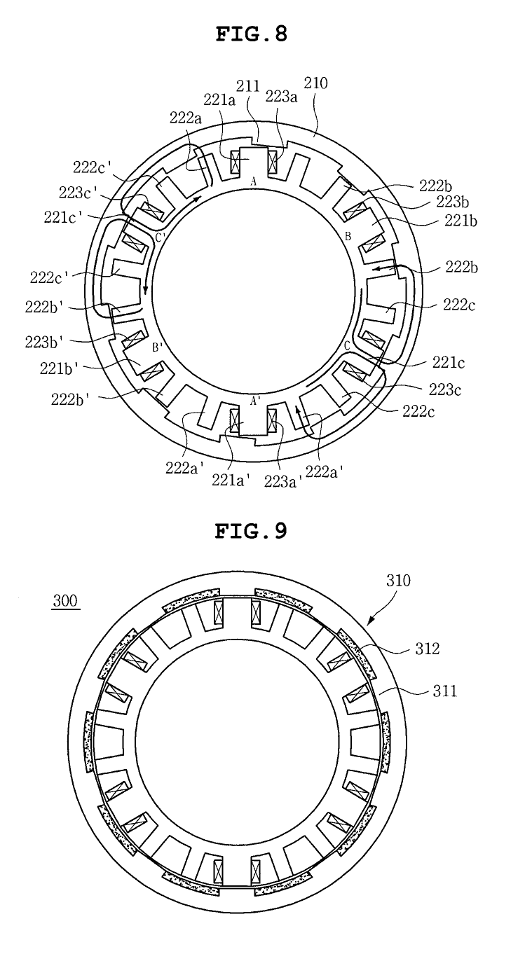

FIG. 8 shows a state in which a C-phase winding is excited by applying a current to the C-phase winding. More specifically, the outer rotor 210 is in a state in which it rotates by 7.2 degrees in a counterclockwise direction as compared to FIG. 7 and by 28.8 degrees in a counterclockwise direction as compared to FIG. 4.

In this case, a magnetic flux generated by applying a current to the C-phase winding 223c, which is a third-phase winding, is bisected in the main salient pole 221c and flows into the auxiliary salient poles of the phase windings adjacent to the C-phase winding 223c at both sides thereof, that is, the auxiliary salient pole 222b of the B-phase winding, which is a second-phase winding, and the auxiliary salient pole 222a′ of the A′-phase winding, which is a first-phase winding, respectively, through the salient pole 211 of the outer rotor 210.

Likewise, a magnetic flux generated by applying a current to the C′-phase winding 223c′, which is a second-phase winding, is bisected in the main salient pole 221c′ and flows into the auxiliary salient poles of the phase windings adjacent to the C′-phase winding 223c′ at both sides thereof; that is, the auxiliary salient pole 222a′ of the A-phase winding, which is a first-phase winding, and the auxiliary salient pole 222b′ of the B-phase winding, which is a second-phase winding, respectively, through the salient pole 211 of the outer rotor 210.

FIG. 9 is a schematic cross-sectional view of a switched reluctance motor including an outer rotor according to another preferred embodiment of the present invention. As shown, a switched reluctance motor 300 including an outer rotor according to another preferred embodiment of the present invention has the same technical configuration as that of the switched reluctance motor 100 according to the first preferred embodiment of the present invention shown in FIG. 2 except that an outer rotor 310 further includes soundproofing materials 312 filled between a plurality of salient poles 311. In addition, the soundproofing material 312 may be a non-magnetic material or an insulating material.

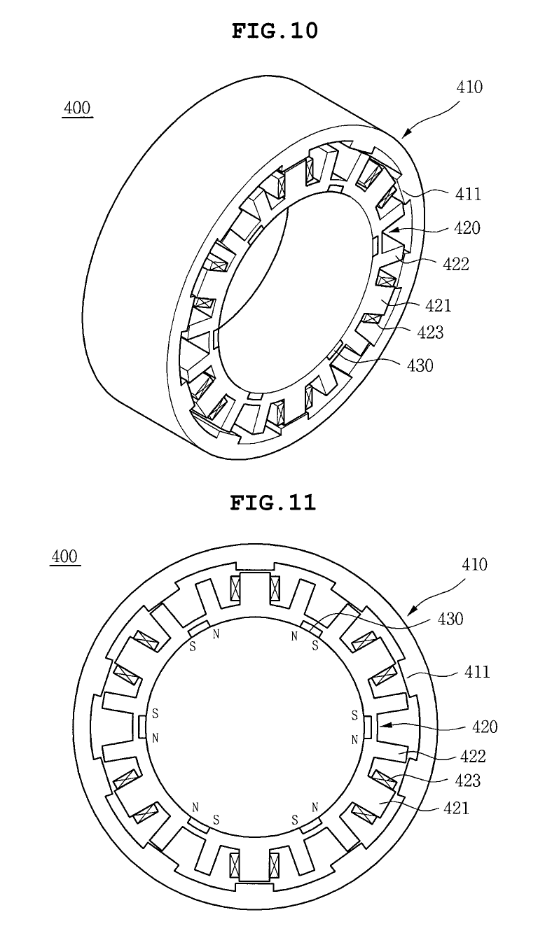

FIG. 10 is a schematic cross-sectional view of a switched reluctance motor according to a second preferred embodiment of the present invention; and FIG. 11 is a schematic perspective view of the switched reluctance motor shown in FIG. 10. As shown, a switched reluctance motor 400 including an outer rotor according to another preferred embodiment of the present invention has the same technical configuration as that of the switched reluctance motor 200 according to the first preferred embodiment of the present invention shown in FIG. 2 except that it further includes magnets positioned between phase-windings.

More specifically, the stator 420 includes insertion grooves formed between auxiliary salient poles thereof; that is, between phase-windings, wherein the insertion groove includes a magnet 430 mounted therein. Torque characteristics are improved by the magnet 430. As shown, adjacent magnets 430 may be disposed to have the same pole.

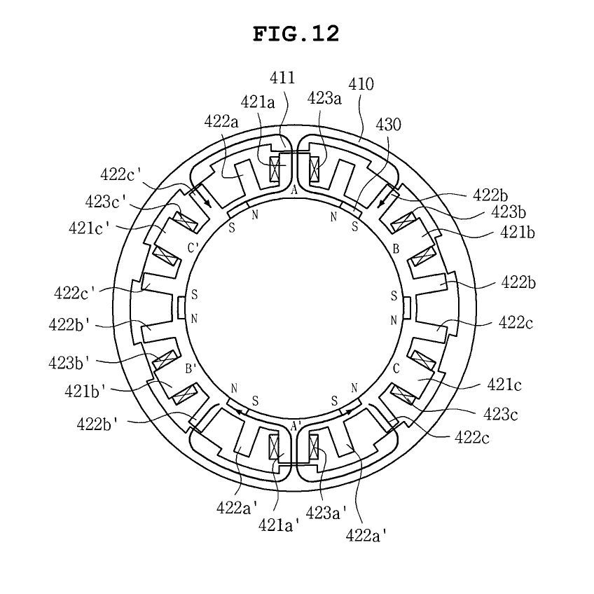

FIGS. 12 to 16 are schematic views showing a use state of the switched reluctance motor shown in FIG. 10. As shown, a switched reluctance 400 according to a third preferred embodiment of the present invention is a three-phase switched reluctance motor and further includes magnets as compared to the switched reluctance motor 200 according to the first preferred embodiment of the present invention as described above.

In addition, as shown in FIG. 12, when an A-phase winding 423a, which is a first-phase winding, has a current applied thereto to be excited, thereby generating a magnetic flux, the magnetic flux is bisected in a main salient pole 421a and flows into auxiliary salient poles of phase windings adjacent to the A-phase winding 423a at both sides thereof; that is, an auxiliary salient pole 422b of a B-phase winding, which is a second-phase winding, and an auxiliary salient pole 422c′ of a C′-phase winding, which is a third-phase winding, respectively, through a salient pole 411 of an outer rotor 410.

Likewise, when an A-phase winding 423a′, which is a first-phase winding, formed at an opposite side to the A-phase winding 423a in a radial direction of the stator 420, has a current applied thereto to be excited, thereby generating a magnetic flux, the magnetic flux is bisected in a main salient pole 421a′ and flows into auxiliary salient poles of phase windings adjacent to the A-phase winding 423a′ at both sides thereof; that is, an auxiliary salient pole 422b′ of a B′-phase winding, which is a second-phase winding, and an auxiliary salient pole 422c of a C-phase winding, which is a third-phase winding, respectively, through the salient pole 411 of the outer rotor 410. Here, magnetic force is increased by the magnet 430, thereby making it possible to obtain improved torque characteristics.

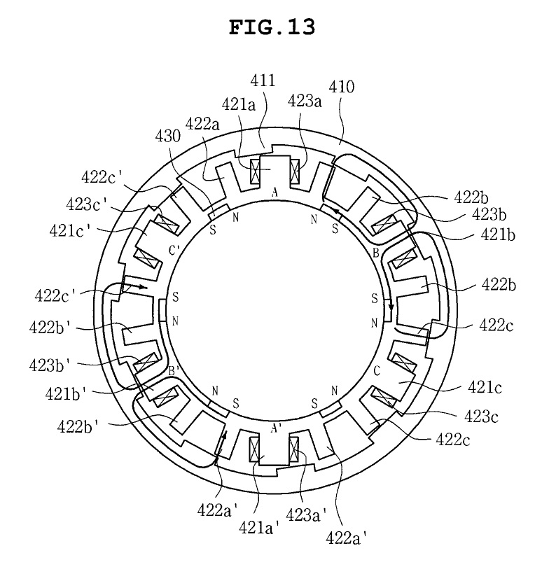

FIG. 13 shows a case in which excitation according to application of a current is changed from the A-phase winding into the B-phase winding, wherein the outer rotor 410 is in a state in which it rotates by 7.2 degrees in a counterclockwise direction as compared to FIG. 12. In this case, a magnetic flux generated by applying a current to a B-phase winding 423b, which is a second-phase winding, is bisected in a main salient pole 421b and flows into auxiliary salient poles of phase windings adjacent to the B-phase winding 423b at both sides thereof, that is, an auxiliary salient pole 422c of a C-phase winding, which is a third-phase winding, and an auxiliary salient pole 422a of an A-phase winding, which is a first-phase winding, respectively, through the salient pole 411 of the outer rotor 410.

Likewise, a magnetic flux generated by applying a current to a B′-phase winding 423b′, which is a second-phase winding, is bisected in a main salient pole 421b′ and flows into auxiliary salient poles of phase windings adjacent to the B′-phase winding 423b′ at both sides thereof, that is, an auxiliary salient pole 422a′ of an A′-phase winding, which is a first-phase winding, and an auxiliary salient pole 422c′ of a C′-phase winding, which is a third-phase winding, respectively, through the salient pole 411 of the outer rotor 410. Here, magnetic force is increased by the magnet 430, thereby making it possible to obtain improved torque characteristics.

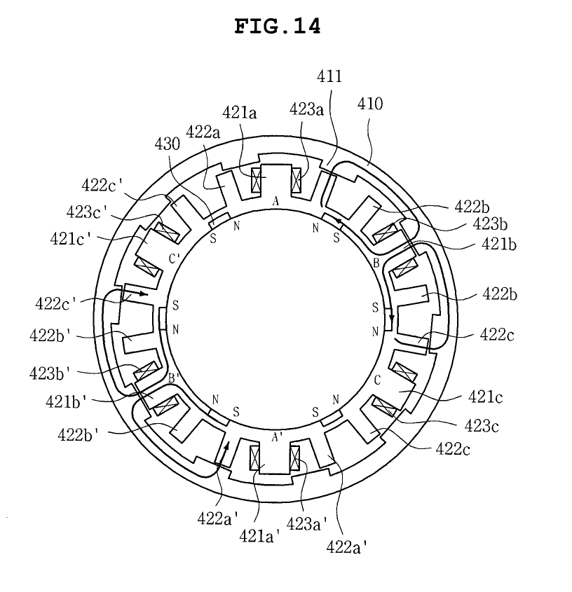

FIG. 14 shows a state in which a B-phase winding is excited by applying a current to the B-phase winding. More specifically, the outer rotor 410 is in a state in which it rotates by 7.2 degrees in a counterclockwise direction as compared to FIG. 13 and by 14.4 degrees in a counterclockwise direction as compared to FIG. 12. In this case, a magnetic flux generated by applying a current to the B-phase winding 423b, which is a second-phase winding, is bisected in the main salient pole 421b and flows into the auxiliary salient poles of the phase windings adjacent to the B-phase winding 423b at both sides thereof, that is, the auxiliary salient pole 422c of the C-phase winding, which is a third-phase winding, and the auxiliary salient pole 422a of the A-phase winding, which is a first-phase winding, respectively, through the salient pole 410 of the outer rotor 411.

Likewise, a magnetic flux generated by applying a current to the B′-phase winding 423b′, which is a second-phase winding, is bisected in the main salient pole 421b′ and flows into the auxiliary salient poles of the phase windings adjacent to the B′-phase winding 423b′ at both sides thereof, that is, the auxiliary salient pole 422a′ of the A′-phase winding, which is a first-phase winding, and the auxiliary salient pole 422c′ of the C′-phase winding, which is a third-phase winding, respectively, through the salient pole 410 of the outer rotor 411. Here, magnetic force is increased by the magnet 430, thereby making it possible to obtain improved torque characteristics.

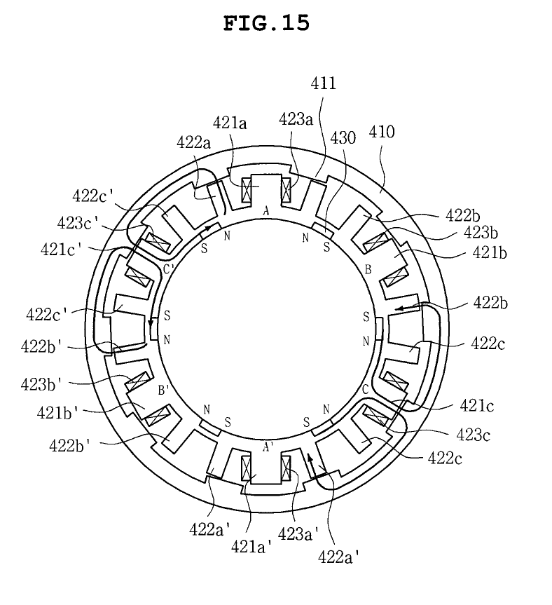

FIG. 15 shows a state in which excitation according to application of a current is changed from the B-phase winding into the C-phase winding, wherein the outer rotor 210 is in a state in which it rotates by 7.2 degrees in a counterclockwise direction as compared to FIG. 14 and by 21.6 degrees in a counterclockwise direction as compared to FIG. 12.

In this case, a magnetic flux generated by applying a current to a C-phase winding 423c, which is a third-phase winding, is bisected in a main salient pole 421c and flows into auxiliary salient poles of phase windings adjacent to the C-phase winding 423c at both sides thereof, that is, an auxiliary salient pole 422b of a B-phase winding, which is a second-phase winding, and an auxiliary salient pole 422a′ of an A′-phase winding, which is a first-phase winding, respectively, through the salient pole 411 of the outer rotor 410.

Likewise, a magnetic flux generated by applying a current to a C′-phase winding 423c′, which is a second-phase winding, is bisected in the main salient pole 421c′ and flows into auxiliary salient poles of phase windings adjacent to the C′-phase winding 423c′ at both sides thereof, that is, an auxiliary salient pole 422a′ of an A-phase winding, which is a first-phase winding, and an auxiliary salient pole 422b′ of a B-phase winding, which is a second-phase winding, respectively, through the salient pole 411 of the outer rotor 410. Here, magnetic force is increased by the magnet 430, thereby making it possible to obtain improved torque characteristics.

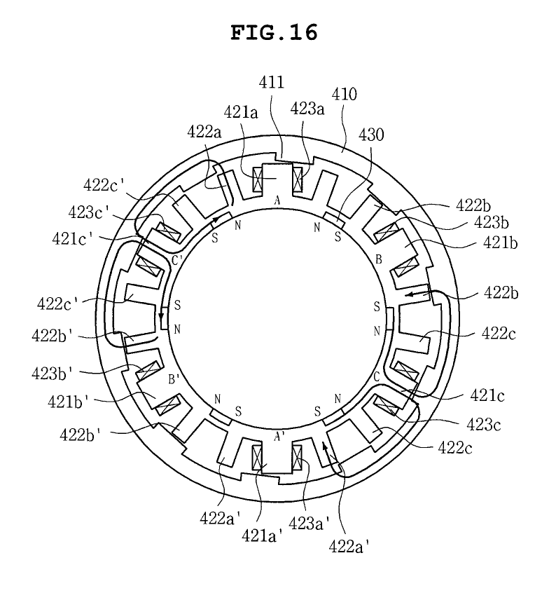

FIG. 16 shows a state in which a C-phase winding is excited by applying a current to the C-phase winding. More specifically, the outer rotor 410 is in a state in which it rotates by 7.2 degrees in a counterclockwise direction as compared to FIG. 15 and by 28.8 degrees in a counterclockwise direction as compared to FIG. 12.

In this case, a magnetic flux generated by applying a current to the C-phase winding 423c, which is a third-phase winding, is bisected in the main salient pole 421c and flows into the auxiliary salient poles of the phase windings adjacent to the C-phase winding 423c at both sides thereof; that is, the auxiliary salient pole 422b of the B-phase winding, which is a second-phase winding, and the auxiliary salient pole 422a′ of the A′-phase winding, which is a first-phase winding, respectively, through the salient pole 411 of the outer rotor 410.

Likewise, a magnetic flux generated by applying a current to a C′-phase winding 423c′, which is a second-phase winding, is bisected in the main salient pole 421c′ and flows into auxiliary salient poles of phase windings adjacent to the C′-phase winding 423c′ at both sides thereof; that is, an auxiliary salient pole 422a′ of an A-phase winding, which is a first-phase winding, and an auxiliary salient pole 422b′ of a B-phase winding, which is a second-phase winding, respectively, through the salient pole 411 of the outer rotor 410. Here, magnetic force is increased by the magnet 430, thereby making it possible to obtain improved torque characteristics.

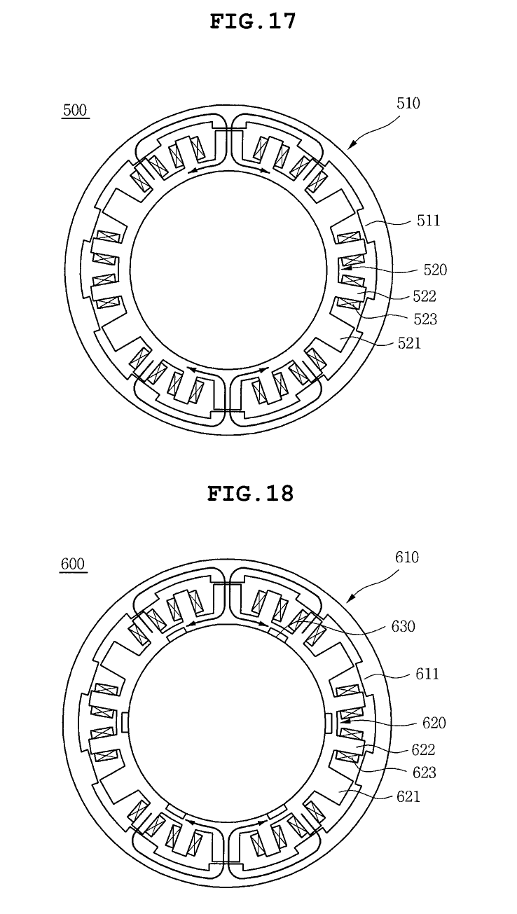

FIG. 17 is a schematic cross-sectional view of a switched reluctance motor according to a third preferred embodiment of the present invention. As shown, a switched reluctance motor 500 according to a third preferred embodiment of the present invention includes an outer rotor 510 and a stator 520, wherein the outer rotor 510 rotates in one direction by a reluctance torque with the stator 520.

More specifically, the outer rotor 510 is provided with a plurality of salient poles 511 protruded at equidistance along an inner peripheral surface thereof.

In addition, the stator 520 is provided in the outer rotor 510 and is provided with a plurality of stator cores including main salient poles 521 and auxiliary salient poles 522 that are protruded toward the salient poles 511 of the outer rotor.

In addition, the auxiliary salient poles 522 have coils 523 wound therearound to form phase windings, and the main salient poles 521 serve as a bridge when a magnetic flux flows and are positioned as the auxiliary salient poles 522, without a coil wound therearound.

Through the above-mentioned configuration, the magnetic flux generated in the main salient pole is bisected and flows into auxiliary salient poles of adjacent phase windings, as shown in an arrow. To this end, the main salient pole 521 according to the third preferred embodiment of the present invention may have a cross-sectional area larger, for example, two times larger than that of the auxiliary salient pole 522 in a direction perpendicular to a shaft.

Through the above-mentioned configuration, in the switched reluctance motor 500 according to the third preferred embodiment of the present invention, the number of salient poles having the coil wound therearound is increased twice; however turns are reduced in half, as compared to the switched reluctance motor according to the first preferred embodiment shown in FIG. 2, such that the entire amount of the coil is constantly maintained.

FIG. 18 is a schematic cross-sectional view of a switched reluctance motor according to a fourth preferred embodiment of the present invention. As shown, a switched reluctance motor 600 including an outer rotor according to another preferred embodiment of the present invention has the same technical configuration as that of the switched reluctance motor 500 according to the third preferred embodiment of the present invention except that it further includes magnets 630 positioned between phase-windings.

More specifically, the stator 620 includes insertion grooves formed between auxiliary salient poles thereof, that is, between phase-windings, wherein the insertion groove includes a magnet 630 mounted therein. Torque characteristics are improved by the magnet 630.

As set forth above, according to the preferred embodiments of the present invention, it is possible to obtain the switched reluctance motor in which the stator core provided with the main salient poles around which the coils are wound and the auxiliary salient poles around which coils are not wound is provided, the magnetic flux is bisected in the main salient pole and flows into the auxiliary salient poles of adjacent phase windings, such that a short magnetic flux route is implemented, thereby making it possible to reduce core loss, and the magnet is provided, thereby making it possible to improve torque characteristics.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A switched reluctance motor comprising:
an outer rotor provided with a plurality of salient poles protruded at equidistance along an inner peripheral surface thereof; and
a stator provided in the outer rotor, provided with a plurality of stator cores including main salient poles protruded toward the salient poles of the outer rotor and including coils wound therearound and auxiliary salient poles positioned at both sides of the main salient poles, and having phase windings in which the coils are wound around the main salient poles.

2. The switched reluctance motor as set forth in claim 1, wherein a magnetic flux generated due to excitation of the phase winding of the stator is bisected in the main salient pole and flows into auxiliary salient poles of adjacent phase windings.

3. The switched reluctance motor as set forth in claim 2, wherein the main salient pole has a cross-sectional area larger than that of the auxiliary salient pole in a direction perpendicular to a shaft.

4. The switched reluctance motor as set forth in claim 1, wherein ten salient poles of the outer rotor are formed at equipitch with respect to a circumferential direction, six main salient poles of the stator are formed at equipitch with respect to the circumferential direction, the coils are wound around the main salient poles to form three-phase windings, and twelve auxiliary salient poles are formed at both sides of the main salient poles.

5. The switched reluctance motor as set forth in claim 1, wherein the outer rotor further includes soundproofing materials filled between the salient poles thereof.

6. The switched reluctance motor as set forth in claim 5, wherein the soundproofing material is a non-magnetic material or an insulating material.

7. A switched reluctance motor comprising:
an outer rotor provided with a plurality of salient poles protruded at equidistance along an inner peripheral surface thereof; and
a stator provided in the outer rotor, provided with a plurality of stator cores including main salient poles protruded toward the salient poles of the outer rotor and including coils wound therearound and auxiliary salient poles positioned at both sides of the main salient poles, having phase windings in which the coils are wound around the main salient poles, and including magnets mounted between the phase windings.

8. The switched reluctance motor as set forth in claim 7, wherein a magnetic flux generated due to excitation of the phase winding of the stator is bisected in the main salient pole and flows into auxiliary salient poles of adjacent phase windings.

9. The switched reluctance motor as set forth in claim 7, wherein the main salient pole has a cross-sectional area larger than that of the auxiliary salient pole in a direction perpendicular to a shaft.

10. The switched reluctance motor as set forth in claim 7, wherein ten salient poles of the outer rotor are formed at equipitch with respect to a circumferential direction, six main salient poles of the stator are formed at equipitch with respect to the circumferential direction, the coils are wound around the main salient poles to form a three-phase winding, and twelve auxiliary salient poles are formed at both sides of the main salient poles.

11. A switched reluctance motor comprising:
an outer rotor provided with a plurality of salient poles protruded at equidistance along an inner peripheral surface thereof; and
a stator provided in the outer rotor, provided with a plurality of stator cores including main salient poles protruded toward the salient poles of the outer rotor and auxiliary salient poles positioned at both sides of the main salient poles and including coils wound therearound, and having phase windings in which the coils are wound around the main salient poles.

12. The switched reluctance motor as set forth in claim 11, wherein the main salient pole has a cross-sectional area larger than that of the auxiliary salient pole in a direction perpendicular to a shaft.

13. A switched reluctance motor comprising:
an outer rotor provided with a plurality of salient poles protruded at equidistance along an inner peripheral surface thereof; and
a stator provided in the outer rotor, provided with a plurality of stator cores including main salient poles protruded toward the salient poles of the outer rotor and auxiliary salient poles positioned at both sides of the main salient poles and including coils wound therearound, having phase windings in which the coils are wound around the main salient poles, and including magnets mounted between the phase windings.

14. The switched reluctance motor as set forth in claim 13, wherein the main salient pole has a cross-sectional area larger than that of the auxiliary salient pole in a direction perpendicular to a shaft.
